(19) United States
(12) Patent Application Publication
(10) Pub. No.: US 2009/0183192 A1
(43) Pub. Date: Jul. 16, 2009

(54) Locking structure for fixing the disk piece

(76) Inventor: Chin Chang Kuo, Taipei (TW)

Correspondence Address: CHIN CHANG KUO, 18F., NO. 71, SEC. 2, DUNHUA S. ROAD, TAIPEI, TW

(21) Appl. No.: 12/008,237

(22) Filed: Jan. 10, 2008

(51) Int. Cl. G11B 23/03

(52) U.S. Cl. 720/728

(57) ABSTRACT

A locking structure for fixing the disk piece, which comprises: a dish seat including a base portion and a plenty of flexible arms, and a pressing unit including a locking portion for locking the disk piece. Each flexible arm connects to the base portion, and protrudes outwardly from the base portion. The base portion has an adhesive face for sticking on any article or place. The pressing unit forms on the center of the dish seat, each flexible arm protrudes from the base portion and connects to the pressing unit. The locking structure of the present invention can be installed on any article or place, and fix the disk piece on the locking structure, so that the disk piece can be fixed on any place. Moreover, the locking structure of the present invention can be accessed easily and has a beautiful appearance.

### BACKGROUND OF THE INVENTION

1. Field of the Invention

The present invention relates generally to a locking structure, in particular to a locking structure for fixing the disk piece on any place. User can stick the disk piece on any place by using of the locking structure. Besides, the locking structure can be accessed easily and has a beautiful appearance.

2. Description of the Prior Art

Recently with the rapidly development of the modern memory access device, the usage of consumer is habitual of fast change, and the utility rate of the disk piece, such as CD or VCD, has been accepted by the public generally. The disk piece is mainly composed of plastic material.

Therefore, the surface of disk piece will be scraped easily, if user doesn't take care and pay attention. For protecting the Integrity surface of disk piece, the disk collector is usually utilized to collect the disk piece, so as to prevent the disk piece from scrape.

Please refers to FIGS. 1-2, shown as a perspective and schematic view of the disk piece collector of the prior art. The disk piece collector 1a comprises: a base seat 10a and a convex portion 11a. The convex portion 11a being installed on the center of the base seat 10a, and the convex portion 11a forms a plenty of convexes 110a, the shape of convexes 110a are shown as actinoid. When a disk piece 12a is installed on the convex portion 11a, the hole 120a of disk piece 12a can be installed around the edge of convex portion 11a, then disk piece 12a is collected on the collector 1a.

However, the convex portion 11a can't fix the disk piece 12a if without other detail members, so that the disk piece 12a is easy to take off from the disk collector 1a. As a result, the surface of disk piece 12a will be scraped by using of the incorrect collect.

The inventor of the present invention recognizes the above shortage should be corrected and special effort has been paid to research this field. The present invention is presented with reasonable design and good effect to resolve the above problems.

### SUMMARY OF THE INVENTION

It is therefore an object of the present invention to provide a locking structure for fixing the disk piece, by using of the design of a dish seat, and the dish seat has a pressing portion and a plenty of flexible arms connected with the pressing portion, each flexible arm is protruded from the bottom of the dish seat. A disk piece can be fixed on an accommodating face of the dish seat through the locking portion of the pressing unit. Additionally, an adhesive face is installed on the bottom of the dish seat, thus the dish seat can be fixed on any article or place.

By using of the cooperation of the flexible arms and the pressing portion, the disk piece might be fixed on any article or place at random. Moreover, the disk piece can decorate for apparel beauty, the pattern collocation of disk piece, or making up the pattern of disk piece.

In order to achieve the above object, the present invention provides a locking structure for fixing the disk piece, which comprises: a dish seat and a pressing unit. The dish seat has a base portion and a plurality of flexible arms connected to the base portion, each flexible arm protruded outwardly from the base portion arranges around the center of the dish seat. The base portion has an adhesive face for sticking on a surface of any article or place. The pressing unit was installed on the center of the dish seat, the flexible arms can be protruded from the base portion and connect to the pressing unit. The pressing unit has a locking portion for locking the disk piece.

The locking structure of the present invention can be installed on any article or place, and fix the disk piece on the locking structure randomly, so that the disk piece can be fixed on any place.

Moreover, the locking structure of the present invention can be accessed easily and has a beautiful appearance.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a perspective view of the first prior art of the disk piece collector;

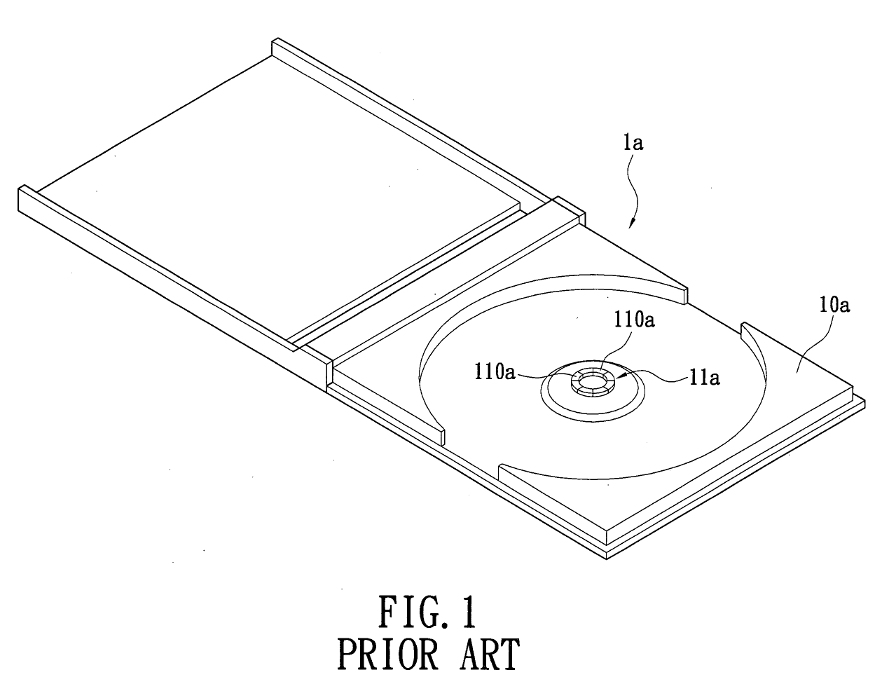

FIG. 2 is a cross-sectional schematic view of a prior art of the disk piece collector structure;

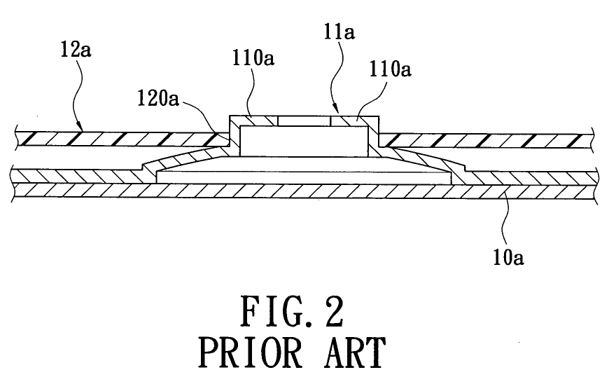

FIG. 3 is a perspective view of a preferred embodiment of the locking structure for fixing the disk piece of the present invention;

FIG. 4 is a top view of FIG. 3 of the locking structure for fixing the disk piece of the present invention:

FIG. 5 is a front view of FIG. 3 of the locking structure for fixing the disk piece of the present invention;

FIG. 6 is a perspective view of the second embodiment of the locking structure for fixing the disk piece of the present invention;

FIG. 7 is an exploded view of FIG. 6 of the locking structure for fixing the disk piece of the present invention;

FIG. 8 is a schematic view of the locking structure for fixing the disk piece which is installed on the wall; and

FIG. 9 is a side view of FIG. 6 of the locking structure for fixing the disk piece of the present invention.

FIG. 10 is a perspective view of the third embodiment of the locking structure for fixing the disk piece of the present invention.

FIG. 11 is another perspective view in FIG. 10 of the locking structure for fixing the disk piece of the present invention.

The drawings will be described further in connection with the following Detailed Description of the Invention.

### DETAILED DESCRIPTION OF THE PREFERRED EMBODIMENTS

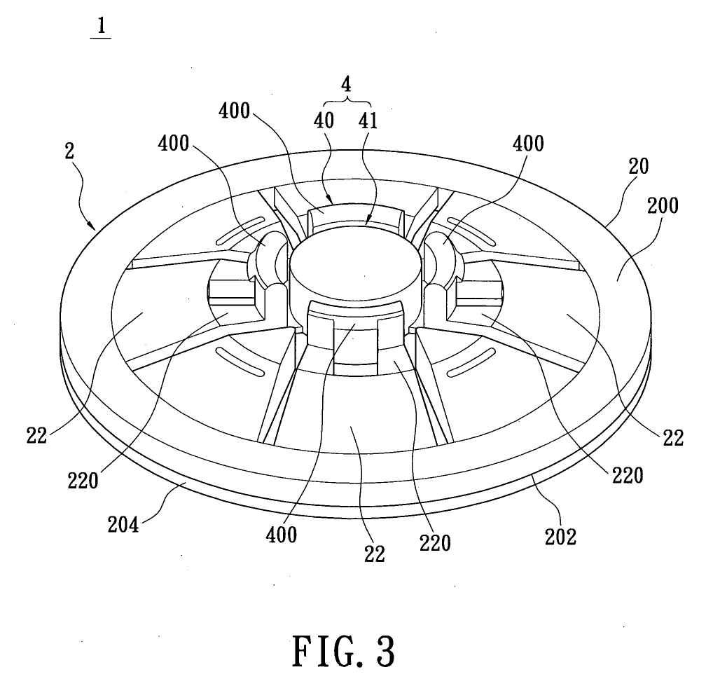

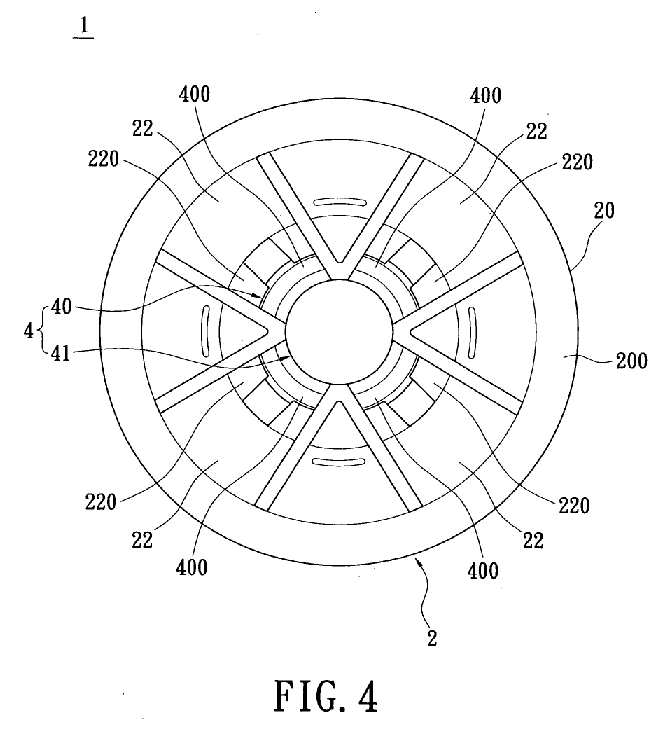

Please refer to FIGS. 3 to 5, shown as a perspective view, top view, and front view of an embodiment of the present invention.

The locking structure for fixing the disk piece 1 comprises: a dish seat 2 and a pressing unit 4. They both forms integrally, and be made of the plasticity material, so that the dish seat 2 and the pressing unit 4 have a flexible force.

The dish seat 2 is a miniature dish seat, and the shape of the dish seat 2 can be designed as circuit-type, rectangle-type, polygon-type or other correlative geometric-type, through the design of the dish seat 2, it is portable to for the user. In the embodiment of present invention, the dish seat 2 is designed as circuit-type. The dish seat 2 includes a base portion 20 and a plurality of flexible arms 22, the base portion 20 has a extended portion 200 and an adhesive face 202 contrast to the extended portion 200, the adhesive face 202 arranges a fixed member 204 which being used to fix on any article or place. Through the fixed member 204 of adhesive face 202, the dish seat 2 can be fixed on any surface of the article, such as a wall, glass or desk. Each flexible arm 22 being extended and protruded outwardly from the extended face 200, each flexible arm 22 is designed to arrange around the center of dish seat 2, so as to form an actinoid-shape. In the embodiment of present invention, the shape of the flexible arms 22 is approximately triangle or trapezium.

In the present invention, the fixed member 204 is a twin adhesive or sucker, through the design of fixed member 204, the adhesive face 202 can be fixed on any article or place easily.

The pressing unit 4 arranged on the center of the dish seat 2 connects each flexible arm 22, and the pressing unit 4 pushes the flexible arms 22 to shrink synchronously. Besides, the pressing unit 4 includes a locking portion 40 and a button-pressing portion 41, the locking portion 40 has a plurality of button-press members 400, each button-press member 400 formed on each flexible arm 22 and arrange around the center of dish seat 2, as to form an arc-shape.

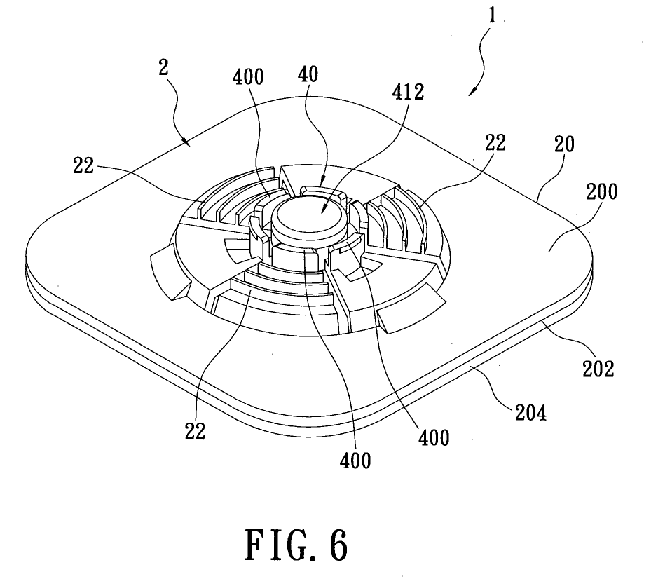

In the embodiment of the present invention, the total amount of the button-press members 400 can be four. Each two button-press members 400 are relative with each other, and the button-press members 400 can be arranged to form the locking portion 40 for locking the circle center 60 of the disk piece 6 (as shown in FIG. 6). The button-pressing portion 41 is located at the center of dish seat 2, and connects to each flexible arm 22, when the button-pressing portion 41 is pressed by use, the flexible arms 22 will shrink inwardly.

In the embodiment of present invention, the button-pressing portion 41 is circle-shape button. However, the shape of button-pressing portion 41 can be designed to any geometric. Thereby, through each component of the locking structure for fixing the disk piece 1, if user press down the button-pressing portion 41 of pressing unit 4, each flexible arm 22 and each button-pressing member 400 of the locking portion 40 will shrink inwardly, so as to make the circle center 60 of the disk piece 6 take off or fix on the pressing unit 4.

Moreover, each flat surface formed between connecting of each flexible arm 22 and the pressing unit 4. Each flat surface is parallel to the base portion 20, the flat surfaces are arranged around the button-pressing portion 41, to form an accommodating face 220 for providing the disk piece 6 install on the dish seat 2 steadily, the disk piece 6 can be fixed steadily by the locking portion 40 of pressing unit 4.

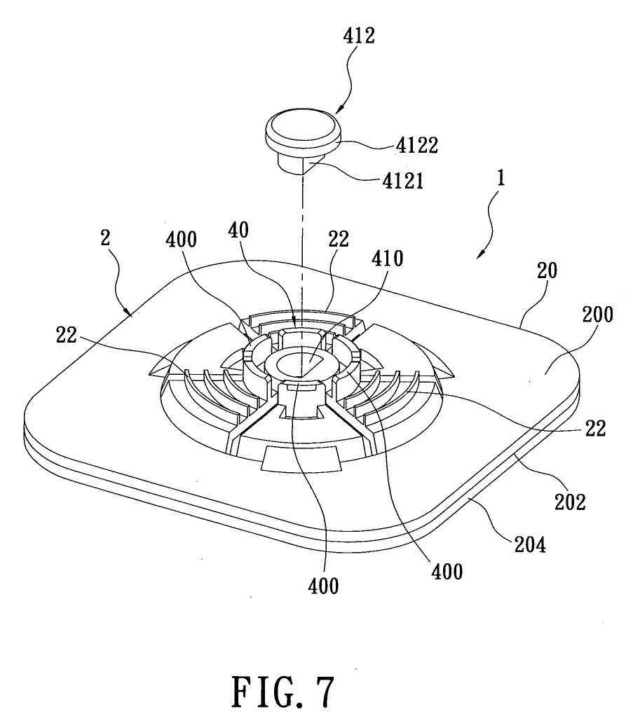

Please refer to FIGS. 6 and 7, the difference between the first and second embodiment is:

The dish seat 2 is a rectangle shape, and the button-pressing portion 41 has a button hole 410 and a button-pressing member 412, the button hole 410 forms on the center of dish seat 2, the button member 412 can be arranged on the button hole 410. In the structure of button member 412, a connecting part 4121 and a heading part 4122 connected with the connecting part 4121 are provided. The connecting part 4121 matches up with the button hole 410, and the heading part 4122 fix on the center of the dish seat 2. Besides, the shape of heading part 4122 can be designed to any geometric, such as circle-shape, heart-shape, star-shape, sphere-shape or other relative shape.

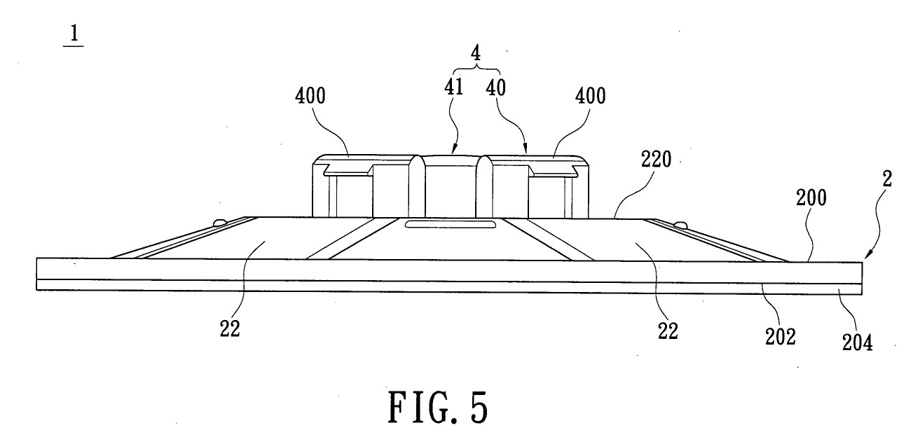

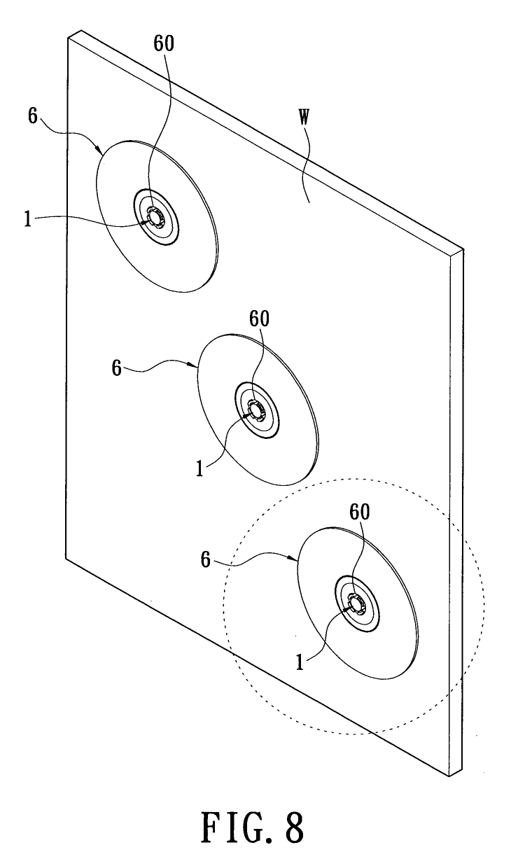

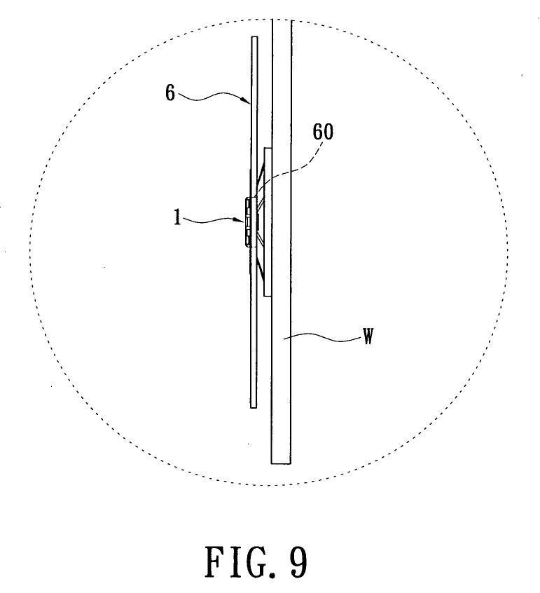

Please refer to FIGS. 5, 8, and 9, wherein, the fixed member 204 of adhesive face 202 of the dish seat 2 can stick on the surface of the wall W, the circle hole 60 of the disk piece 6 can be hitched on the pressing unit 4 through the cooperation of the locking portion 40 and the button-pressing portion 41, and the disk piece 6 can be installed on the accommodating face 220 steadily.

The locking structure for fixing the disk piece 1 can be fixed on the wall W, and the disk piece 6 can be fixed on the locking structure for fixing the disk piece 1, so that the disk piece 6 can decorate for apparel beauty, the pattern collocation of the disk piece 6, or making up the pattern of disk piece 6. Additionally, the disk piece 6 can access and change the arrangement.

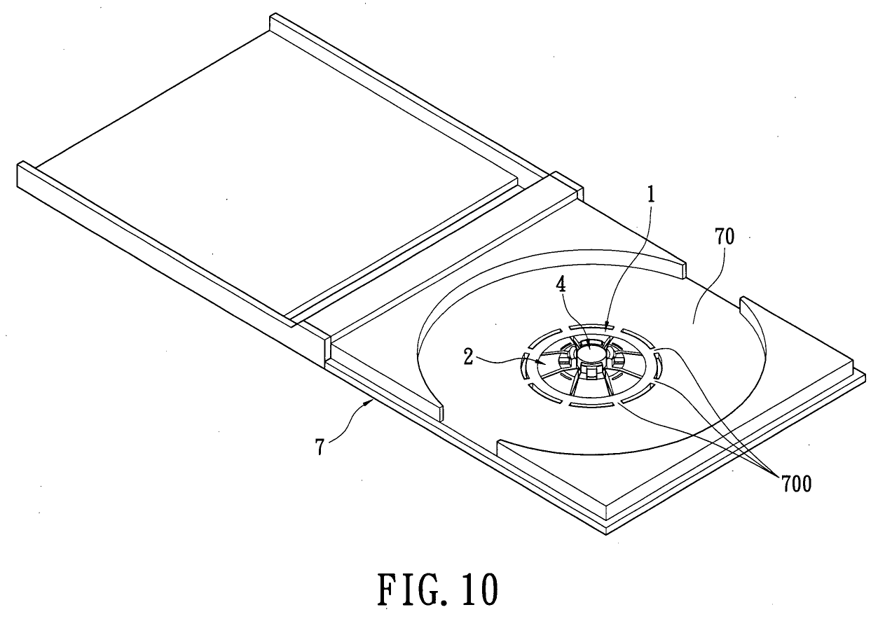

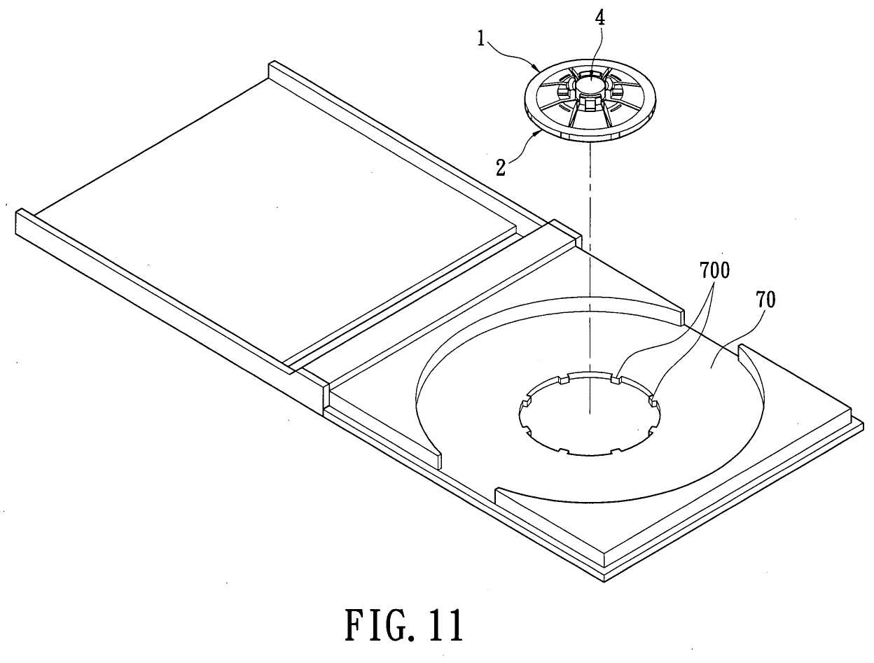

Please refer to FIGS. 10 and 11, shown another embodiment. In this embodiment of the present invention, the dish seat 2 is arranged on the base seat 70 of the disk piece collector 7 in disassemble way. The center of the base seat 70 includes a plenty of connecting portion 700, those connecting portion 700 connect around the edge of the dish seat 2 and form the circular arrangement. Every connecting portion 700 is separated to another connecting portion 700. By using of the design of those connecting portions 700, the dish seat 2 of the locking structure for fixing the disk piece 1 can be easily separated from the base seat 70 of the disk piece collector 7 in disassemble way.

Therefore, the disk piece 6 can be arranged, accessed or collected by user at random through the design of present invention.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A locking structure for fixing the disk piece, comprises:
a dish seat having a base portion and a plurality of flexible arms, the base portion including an extending face and a adhesive face contrasted to the extending face, each flexible arm protruded outwardly from the extending face, and the flexible arms arranged around the center of the dish seat, the adhesive face having a fixing member; and
a pressing unit arranged on the center of the dish set, the flexible arms protruded outwardly and connected to the pressing unit, the pressing unit having a locking portion for locking the dish piece.

2. The locking structure for fixing the disk piece as claimed in claim 1, wherein the fixing member is twin adhesive or sucker, the adhesive face fixed on any article or place by using of the twin adhesive or sucker.

3. The locking structure for fixing the disk piece as claimed in claim 1, wherein an accommodating face formed on connecting place of the flexible arms and the pressing unit.

4. The locking structure for fixing the disk piece as claimed in claim 1, wherein the locking portion having a plurality of locking member, each locking member formed on each flexible arm for locking the dish piece.

5. The locking structure for fixing the disk piece as claimed in claim 1, wherein the dish set and the pressing unit being formed integrally, and they both are plastic material.

6. The locking structure for fixing the disk piece as claimed in claim 1, wherein the flexible arms formed as trilar-shape, and the flexible arms arranged with interval each other.

7. The locking structure for fixing the disk piece as claimed in claim 1, wherein the pressing unit further having a press-forcing portion for driving the flexible arms and locking portion shrink inwardly, then make the disk piece take off or on the pressing unit alternatively.

8. The locking structure for fixing the disk piece as claimed in claim 1, wherein the press-forcing portion having a hole formed on the dish set, and a pressing member arranged on the hole separately in alternatively.

9. The locking structure for fixing the disk piece as claimed in claim 1, wherein the dish seat is arranged on a base seat of a disk piece collector in disassemble way.

10. The locking structure for fixing the disk piece as claimed in claim 9, wherein the base seat of the disk piece collector includes a plenty of connecting portions being connected around an edge of the dish seat, the dish seat and the connecting portions connect in disassemble way.
